(19) United States
(12) Patent Application Publication
(10) Pub. No.: US 2005/0247641 A1
(43) Pub. Date: Nov. 10, 2005

(54) Hydraulic system for mobile conveying vehicles

(76) Inventor: Wilhelm Krautler, Koblach (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/122,747

(22) Filed: May 3, 2005

(30) Foreign Application Priority Data
May 4, 2004 (DE) 20 2004 007 062.6

(51) Int. Cl. B01D 35/00

(52) U.S. Cl. 210/741; 210/97; 210/171

(57) ABSTRACT

The present application relates to a hydraulic system for mobile conveying vehicles having a filter plant for the cleaning of the hydraulic oil flow by filtration of particles, having a device for the removal of a defined part flow of the hydraulic oil and having at least one filter element for the filtration of the part flow of hydraulic oil.

### CROSS REFERENCE TO RELATED APPLICATION

This application claims priority to German Patent Application Serial No. DE 202004007062.6 filed May 4, 2004, which is hereby incorporated by reference in its entirety for all purposes.

### FIELD

The present application relates to a hydraulic system for a mobile conveying vehicle.

### BACKGROUND AND SUMMARY

Reach stackers have increasingly been used as mobile conveying vehicles in recent times. Reach stackers are vehicles with rubber tires, a diesel engine and an operator's cabin. They have the capability of transporting and stacking loads, in particular containers, trailers, sheet metal coils, part loads, etc. Previously known reach stackers are fitted with a container spreader arranged as a load receiving means on the telescopic arm, i.e. a lifting and lowering of the spreader only takes place via the telescopic arm. The raising and lowering movement of the telescopic arm and the movement of the spreader takes place hydraulically in this process. Reach stackers can handle or stack fully loaded containers in a multiple manner behind one another and on top of one another. In known reach stackers, the operator's cabins are arranged fixedly or movably connected to the frame in the rear part on the vehicle, whereby the operator has a good view of the container spreader fixedly connected to the telescopic arm.

Hydraulic systems such as are used in mobile conveying vehicles require a pressure medium of a high degree of purity to avoid damage to their components. The cleaning of the pressure medium is therefore necessary to ensure the perfect function of the hydraulic system. It is already known to use high-pressure filter units or backflow filter units which clean the complete hydraulic flow of particles of >10 μm.

It is the object of the present application to provide a hydraulic system in which the contamination particles occurring in the hydraulic system on the wear of the hydraulic components are able to be removed in as quantitative a manner as possible.

In one embodiment, this object is satisfied by providing a hydraulic system which is to be used in mobile conveying vehicles and has a filter unit for the cleaning of the hydraulic flow by filtering particles, and furthermore has a device, for example for the removal of a defined and constant part flow of the hydraulic oil and in which at least one filter element is present for the filtration of the part flow of hydraulic oil. This is a secondary flow filter unit with which a defined and constant oil flow is removed which is matched to the filter element used. This hydraulic oil flow is cleaned of contamination particles in the filter and supplied back to the hydraulic system at a lower pressure level.

The use of very fine filter elements is possible due to the use of a limited hydraulic oil flow so that a filtration of very small particles is possible in the range of 3 μm, such as occur by normal wear in the hydraulic system.

Special aspects of the hydraulic system in accordance with the present application can result from additional features, as discussed below. Accordingly, a hydraulic system can be used particularly advantageously in a reach stacker.

In a further embodiment, a contamination display can be formed in that a pressure gauge is utilized to measure the back pressure applying at the filter.

A protocol unit is particularly advantageously provided to record the back pressure of the filter as a function of time. This can include, for example, a memory of a connected monitoring unit in which the corresponding pressure values are stored as a function of time. The speed of the filter back pressure change can be recorded via a differentiating unit. The speed of the filter back pressure change corresponds to a contamination speed. An abrupt increase in this contamination speed in turn indicates damage in the hydraulic system. A warning signal can be output by a corresponding monitoring of the contamination speed and by setting corresponding limit values for the case that the contamination speed exceeds a pre-set value. A corresponding signal can be indicated by means of a warning lamp in the operator's cabin.

### BRIEF DESCRIPTION OF THE FIGURE

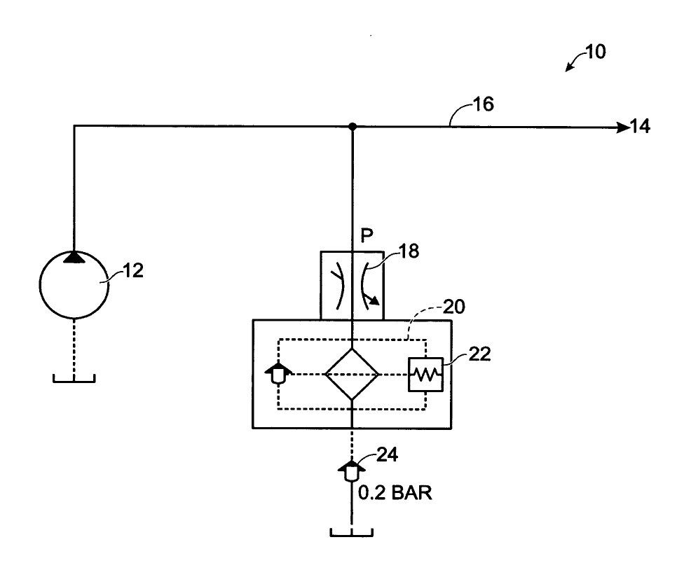

In FIG. 1, an embodiment is shown schematically. The hydraulic system 10, that can, for example, be a hydraulic system of a reach stacker not shown in any further detail here, has a pump for the hydraulic oil 12. The hydraulic oil is supplied to a consumer 14, not shown in any more detail here, via this pump. A defined and constant part flow of hydraulic oil is removed from the hydraulic oil line 16 of the hydraulic system 10 and supplied to a filter 20 by means of a restrictor 18 used here. A pressure pick-up 22 is associated with the filter 20. A check valve 24 is provided after the filter 20. The hydraulic flow guided via the filter element 20 with very fine pores is then again guided to the hydraulic system at a lower pressure level. A volume control, a flow separator or another device for the removal of a constant part flow can also be used instead of a restrictor 18.

It can be prevented by means of the secondary flow filter unit shown here that a hydraulic component contaminates the whole hydraulic system with particles in the case of damage. Such contaminations can, for example, be flushed into the total system on increased wear in a pump which results in abrasion of the pump material. Consequential damage with otherwise perfectly working components can thus be effectively prevented or reduced.

The system presented in FIG. 1 can particularly preferably be used as an early warning system by use of the pressure pick-up serving as a contamination display.

The contamination display measures the back pressure prior to the filter 20 through which the constant hydraulic oil transport flow flows. This back pressure is utilized as a measure for the contamination of the filter by a suitable display. On reaching a specific pressure value, the necessity of replacing the filter element is signaled. A warning lamp not shown in any more detail can be provided in the operator's cabin for this purpose.

To utilize the contamination display, the back pressure is recorded in a protocol unit (not shown in any more detail here) over the whole period of use of the hydraulic system.

A contamination speed results from a differentiation of the back pressure by time. An abrupt increase in this contamination speed indicates damage in the hydraulic system. Such damage can, for example, be an increased introduction of contamination from outside through a defective seal. On the other hand, the running parts of a pump can be damaged and increased wear can thereby be caused.

1. A hydraulic system for mobile conveying vehicles having a filter plant for the cleaning of the hydraulic oil flow by filtration of particles, the system comprising a device for removal of a defined part of a flow of the hydraulic oil and having at least one filter element for filtration of the partial flow of hydraulic oil.

2. A hydraulic system in accordance with claim 1, wherein the mobile vehicle is a reach stacker.

3. A hydraulic system in accordance with either of claim 1, where a pressure gauge serves as a contamination display for measurement of a back pressure being applied at the filter.

4. A hydraulic system in accordance with claim 3, further comprising a protocol unit for recording of the back pressure of the filter as a function of time and by a differentiation unit for determination of a speed of a change in filter back pressure.

5. A system comprising:
a reach stacker;
a hydraulic system coupled to the reach stacker, said system having a filter plant for the cleaning of the hydraulic oil flow by filtration of particles, the system comprising a device for removal of a defined and constant part of a flow of the hydraulic oil and having at least one secondary filter element for filtration of the partial and constant flow of hydraulic oil.

6. A hydraulic system in accordance with claim 5, wherein the secondary filter element is matched to said defined and constant oil flow.

7. A hydraulic system in accordance with either of claim 5, where a pressure gauge serves as a contamination display for measurement of a back pressure being applied at the filter.

8. A hydraulic system in accordance with claim 7, further comprising a protocol unit for recording of the back pressure of the filter as a function of time and by a differentiation unit for determination of a speed of a change in filter back pressure.

9. A hydraulic system in accordance with claim 7, wherein said device includes at least one of a flow restrictor, a volume control, and a flow separator.

10. A method for filtering hydraulic oil in a hydraulic system of a reach stacker, the method comprising:
pressurizing hydraulic oil from the hydraulic system and providing said pressurized oil to an oil line;
removing a defined flow portion of the pressurized hydraulic oil from the oil line;
filtering the defined flow portion separately from remaining oil in said oil line via a filter; and
supplying said filtered defined flow portion back to the hydraulic system at a lower pressure level.

11. The method of claim 10 wherein said removing includes removing a defined and constant flow portion.

12. The method of claim 11 wherein said removing includes restricting flow to said filter.

13. The method of claim 12 wherein said restrictor is sized to provide said defined portion.

14. The method of claim 10 further comprising sensing oil pressure of said removed flow portion.

15. The method of claim 14 wherein said pressure includes a back pressure applied by said filter.

16. The method of claim 15 further comprising indicating a change of said filter back pressure.

17. The method of claim 15 further comprising indicating contamination via a speed of change of said filter back pressure.
